(19) United States
(12) Patent Application Publication
(10) Pub. No.: US 2025/0282325 A1
(43) Pub. Date: Sep. 11, 2025

(54) REAR WINDOW WIPER RECEPTACLE AND DRIVE SYSTEM

(71) Applicant: Rivian IP Holdings, LLC, Irvine, CA (US)

(72) Inventors: Edgar MEDINA, Irvine, CA (US); Koushik VEERAMACHANENI, Irvine, CA (US); Hao SUN, Tustin, CA (US); Richard SUKHDEO, Lake Forest, CA (US); Phillip WHITTON, Irvine, CA (US); Achilleas DOUFAS, Irvine, CA (US); David TOBON, Northville, MI (US)

(21) Appl. No.: 19/072,346

(22) Filed: Mar. 6, 2025

Related U.S. Application Data
(60) Provisional application No. 63/563,267, filed on Mar. 8, 2024.

(51) Int. Cl. B60S 1/04; B60S 1/08; B60S 1/58

(52) U.S. Cl. CPC B60S 1/0402; B60S 1/0447; B60S 1/08; B60S 1/583

(57) ABSTRACT

A vehicle door defines a window opening and include a structure having a surface defining a portion of a lower edge of the window opening and a recess extending downwardly from the surface. A window extends across the window opening. A window wiper is mounted to the structure and has a parked position in which the window wiper is positioned in the recess. The structure may be an applique and the recess may include a perforated wall permitting drainage into a channel defined by the applique. A drive unit for driving the window wiper may be mounted to a structural portion of the applique with non-structural portions extending to either side. A heating element may be mounted to the recess to facilitate melting of snow and ice. The drive unit may include a motor with an axis of rotation perpendicular to an axis of rotation of the window wiper.

### RELATED APPLICATIONS

This application claims the benefit of U.S. Application Ser. No. 63/563,267 filed Mar. 8, 2024, and entitled HIDDEN REAR WIPER DESIGN, which is hereby incorporated herein by reference in its entirety.

### INTRODUCTION

The present disclosure relates to receptacle for a rear wiper and a drive system for driving the rear wiper.

### SUMMARY

The present disclosure describes an approach for implementing a window wiper on a door of a vehicle. In one aspect, a vehicle door defines a window opening, the vehicle door including a structure having a surface defining a portion of a lower edge of the window opening and a recess extending downwardly from the surface. A window extends across the window opening. A window wiper is mounted to the structure and has a parked position in which the window wiper is positioned in the recess.

### BRIEF DESCRIPTION OF THE DRAWINGS

FIG. 1 illustrates a rear liftgate of a vehicle with a rear window wiper and a corresponding receptacle in accordance with certain embodiments.

FIG. 2 is an exploded view of the rear liftgate of the vehicle in accordance with certain embodiments.

FIG. 3 illustrates a receptacle for a rear window wiper in accordance with certain embodiments.

FIG. 4 illustrates a drainage channel for the receptacle in accordance with certain embodiments.

FIG. 5 is a cross-sectional view illustrating placement of a heating pad and seals relative to the receptacle in accordance with certain embodiments.

FIG. 6 illustrates a drive motor and drive gears for a rear wiper in accordance with certain embodiments.

FIG. 7 illustrates the mounting of the drive motor and drive gears to an applique in accordance with certain embodiments.

FIG. 8 illustrates a cover for the receptacle in accordance with certain embodiments.

FIG. 9 illustrates placement of a ramp and a Hall effect sensor relative to the receptacle in accordance with certain embodiments.

FIG. 10 is a schematic block diagram of components for controlling a rear wiper in accordance with certain embodiments.

FIG. 11 illustrates various positions of the rear wiper in accordance with certain embodiments.

### DETAILED DESCRIPTION

The aesthetics of a vehicle are very important to buyers. However, successfully achieving a desired look for a vehicle often requires various technical solutions. This disclosure describes an approach for stowing a window wiper when not in use. A structure, such as an applique, is secured to a vehicle door (e.g., a rear liftgate) along the lower edge of window and defines a recess into which the window wiper inserts when parked. The applique defines a perforated wall and a channel below the perforated wall to conduct fluid to an edge of the vehicle door. A drive unit is mounted to the applique and includes a motor with an axis of rotation perpendicular to the axis of rotation of the arm. The applique defines a slot with a seal mounted within the slot. An arm mounting the window wiper to the drive unit moves within a slit defined by the seal. The applique may include a structural portion to which the drive unit is mounted, and which is secured to the vehicle door. Remaining portions of the applique may be non-structural and secured using non-structural fasteners, such as snap fasteners. The applique may be an inner applique that is covered by an outer applique.

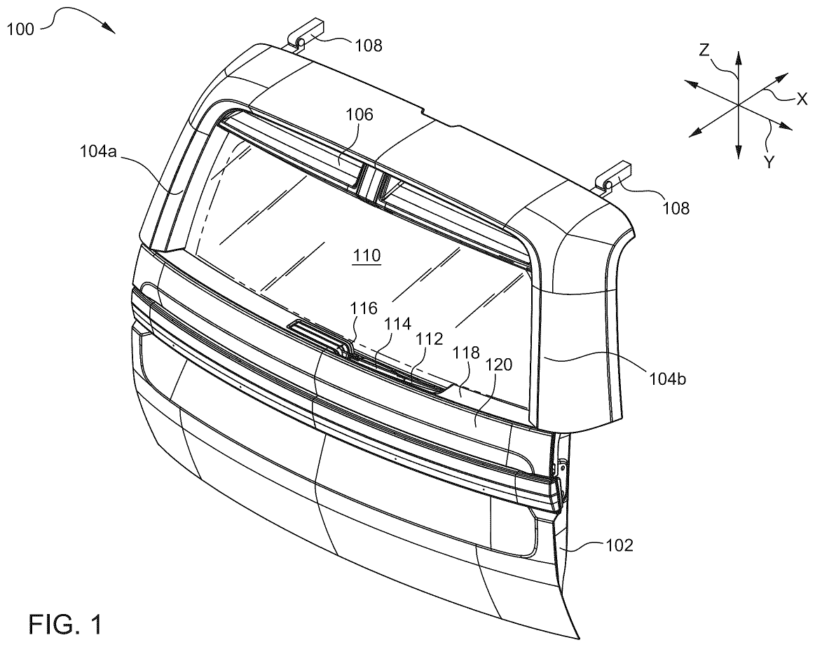

Referring to FIG. 1, a rear liftgate 100 for a vehicle, such as a sport utility vehicle (SUV), hatchback, station wagon, or other type of vehicle, may include a lower panel 102, pillars 104a, 104b connected to the lower panel 102 and extending upwardly from the lower panel 102, and a top frame member 106 that connects to both of the pillars 104a, 104b and is offset above the lower panel 102. The lower panel 102, pillars 104a, 104b, and top frame member 106 are structurally secured to one another to form an integral member. The lower panel 102, pillars 104a, 104b, and top frame member 106 together define a window opening covered by a window 110. The rear liftgate 100 covers a rear opening defined by the vehicle and may be rotated about hinges 108 mounting the rear liftgate 100 to a roof of a vehicle. The window 110 may be openable and may retract within the lower panel 102. The mechanism used to retract the window 110 may be implemented according to any approach known in the art for implementing openable vehicle windows.

Although a rear liftgate 100 is described herein with hinges 108 at the top, any other type of vehicle door may benefit from the embodiments disclosed herein, such as a rear door with side-mounted hinges 108 or a tailgate with bottom-mounted hinges 108. Likewise, the approach described herein may be used with respect to a fixed window that is mounted in a portion of a vehicle that is not some type of vehicle door, e.g., a fixed windshield or rear window.

The approach described herein may be understood with respect to an X and Y direction that are perpendicular to one another. The X direction may be defined as parallel to a direction of travel of the vehicle when steered wheels are oriented straight. The Y direction may be defined as perpendicular to the X direction and the X and Y direction may be perpendicular to the direction of gravity when the vehicle is on a level surface. As used herein the Z direction is perpendicular to the X and Y directions. The axis of rotation of the hinges 108 may be substantially (e.g., within 1 degree of) parallel to the Y direction.

Rain, snow, or other obscurants may be at least partially cleared from the window 110 by a rear wiper 112 mounted to a rear wiper arm 114. Aesthetics of the vehicle may be enhanced by providing a receptacle 116 in which the rear wiper 112 and rear wiper arm 114 seat when not in use.

The receptacle 116 may be defined by an inner applique 118 secured to the lower panel 102 and over a portion of the window 110. An outer applique 120 may secure to the inner applique 118 to cover components mounted to the inner applique 118 as discussed below and for aesthetics.

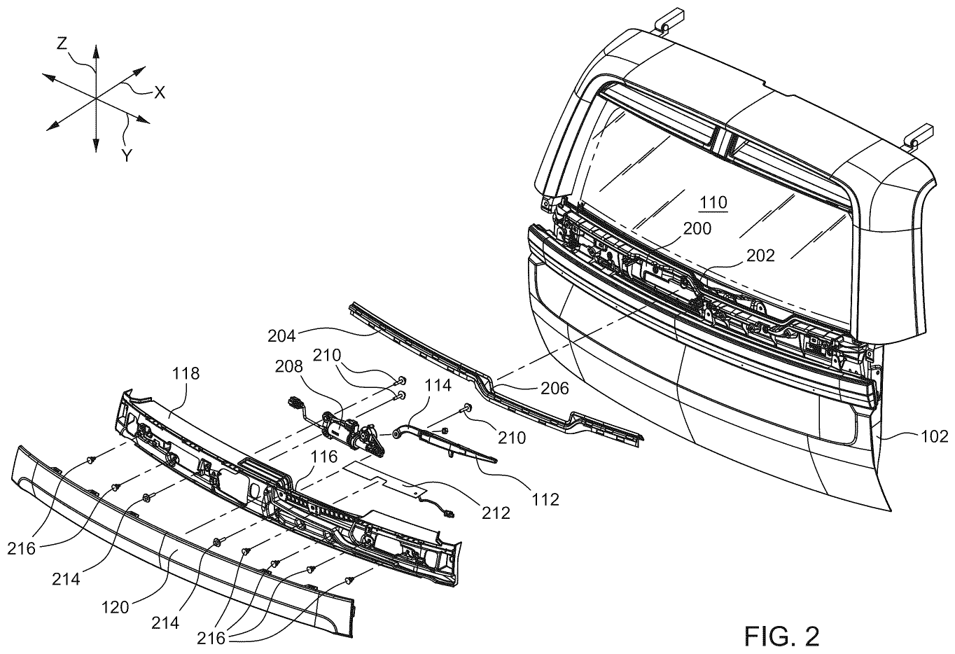

Referring to FIG. 2, the lower panel 102 may define, or have secured thereto, a glass carrier 200 configured to support and retain a lower edge of the window 110. The glass carrier 200 may be a structural member mounted integrally to the lower panel 102 or formed monolithically with the lower panel 102. The glass carrier 200 may define a recess 202 that is aligned with the receptacle 116 when assembled such that the glass of the window 110 extends across the recess 202 in the Y direction and downwardly in the Z direction below portions of the glass carrier 200 that extend in the Y direction on either side of the recess 202.

A seal 204 may extend along a lower edge of the window 110 and be positioned between the glass carrier 200 and the inner applique 118 when assembled. The seal 204 may follow the contours of the glass carrier 200 and therefore define a corresponding recess 206 that extends downwardly in the Z direction along, or under in the Z direction, the recess 202 and recess 116 when assembled. The seal 204 may hinder fluid flow between the glass carrier 200 and the inner applique 118.

A drive unit 208 may mount directly to the inner applique 118 using fasteners 210 that engage the inner applique 118 and the drive unit 208. The fasteners 210 may be structural fasteners, such as steel bolts. The wiper arm 114 mounts to an output of the drive unit 208. The drive unit 208 may be positioned between the inner applique 118 and the glass carrier 200, or another portion of the lower panel 102, when assembled.

A heating element 212 may be mounted to the inner applique 118, e.g., to a portion of the inner applique 118 defining the receptacle 116 in order to melt snow and ice that may collect in the receptacle 116. In addition, a resistive heater incorporated into the window 110 may extend over portions of the window 110 that extend into the recess 202 to further facilitate melting of snow and ice.

Snap fasteners 216 or other non-structural fasteners may be used to secure the outer applique 120 to the inner applique 118, such as after the inner applique 118 is secured to the glass carrier 200. For example, snap fasteners 216 may be secured to the inner applique 118 and portions thereof may protrude outwardly to engage the outer applique 120 and secure the outer applique 120 to the inner applique 118.

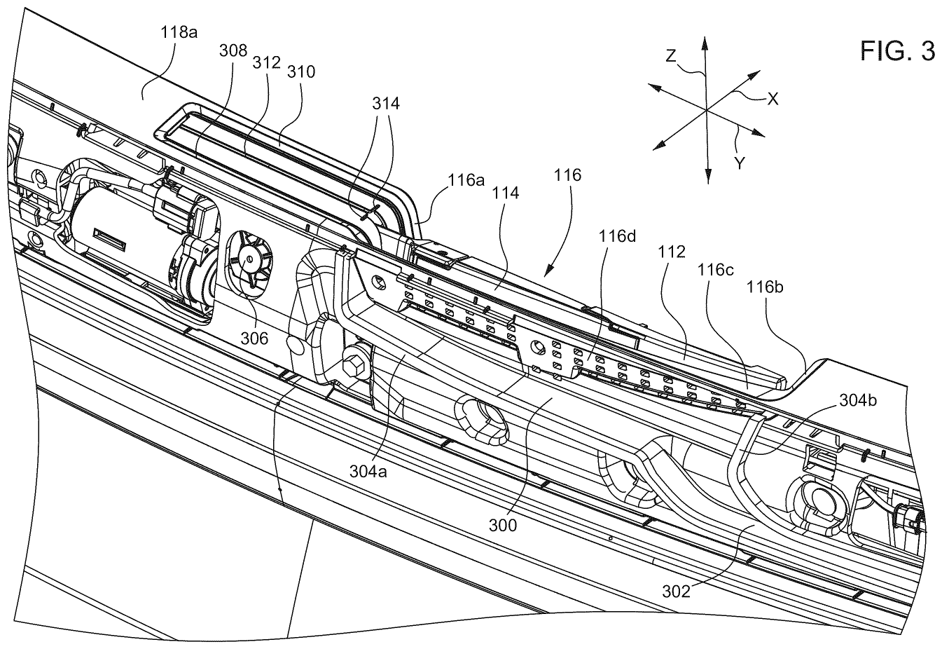

FIG. 3 provides a more detailed view of the recess 116, the recess 116 may include sidewalls 116a, 116b that extend downwardly from an upper surface 118a of the inner applique 118 along the Z direction and are offset from one another along the Z direction. A bottom wall 116c of the recess 116 may extend between the sidewalls 116a, 116b in the Y direction, the bottom wall 116c being offset from the upper surface 118a along the Z direction. The depth of the bottom wall 116c relative to the upper surface 118a along the Z direction may be some multiple of the height of the wiper 112 and wiper arm 114, such as 1.1, 1.2, 1.5, or 2 times the maximum height of the wiper 112 and wiper arm 114 assembly above the bottom wall 116c in the Z direction when parked in the receptacle 116. A forward wall of the receptacle 116 extending between the side walls 116a, 116b and along the bottom wall 116c may be formed by the window 110 or part of the inner applique 118. The bottom wall 116c may be sloped, e.g., sloping downwardly in the Z direction with distance from the window 110 along the X direction. A rearward wall 116d of the receptacle 116 may extend between the sidewalls 116a, 116b and along the bottom wall 116c having the bottom wall 116c positioned between the window 110 and the rear wall 116d. The rear wall 116d may be perforated to allow fluid to drain from the receptacle 116. The rearward wall 116d may be angled, e.g., sloped rearwardly in the X direction with distance from the bottom wall 116c along the Z direction. An upper edge of the rearward wall may be flush with a rearward edge of the upper surface 118a. The perforations in the rearward wall 116d may be sized to resist clogging while also preventing larger particles from passing therethrough. For example, the perforations each have an area of between 0.25 and 2 square centimeters or between 0.5 and 1.5 square centimeters. There may be any number of perforations, such as from 20 to 50 perforations. The rearward mall 116d may also be formed of a metal mesh or screen.

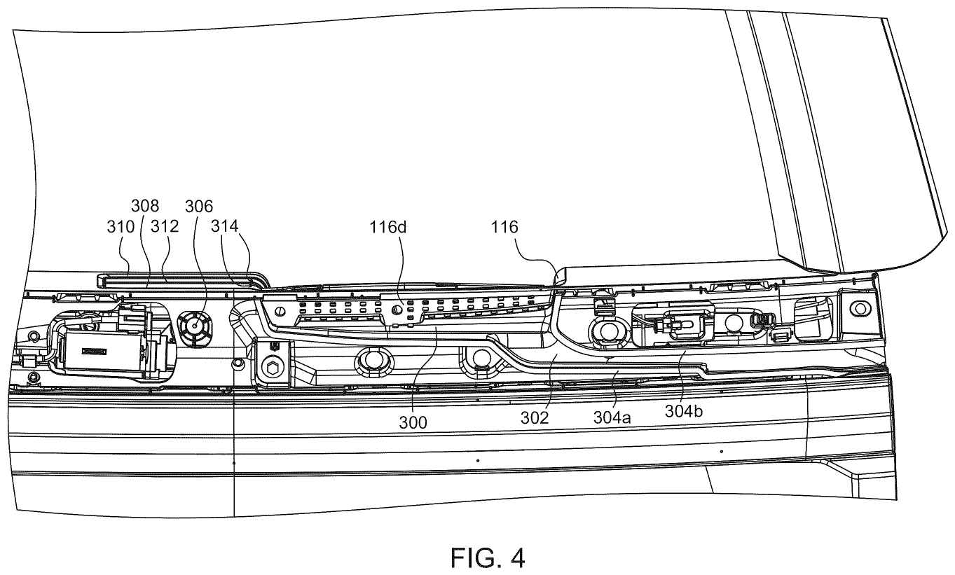

Referring to FIG. 4, while still referring to FIG. 3, beneath the rearward wall, the inner applique 118 may define a collection surface 300. As noted above, the rearward wall 116d may be sloped outwardly in the X direction. The collection surface 300 may extend under the rearward wall 116d in the X direction and along the rearward wall 116d in the Y direction. The collection surface 300 may catch fluid draining through the perforations in the rearward wall 116d. A channel 302 may extend downwardly along the Z direction from the collection surface 300 and outwardly to an edge of the inner applique 118. The collection surface 300 itself may be sloped downwardly to an inlet of the channel 302 to facilitate drainage. Seals 304a, 304b may mount to the inner applique 118 and be captured between the inner applique 118 and the outer applique 120. The seal 304a may extend around one side (e.g., the left side) of the rearward wall 116, the collection surface 300, and a lower side of the channel 302. The seal 304b may extend around the opposite side of the rearward wall 116 (e.g., the right side), and the upper side of the channel 302. The seals 304a, 304b, collection surface 300, and channel 302 may therefore provide a sealed channel from the rearward wall 116 to one side of the inner applique 118. Water exiting the side of the inner applique 118 may drain along a side of the lower panel 102 and then fall from the vehicle.

Continuing with reference to both FIGS. 3 and 4, an axis of rotation 306 of the wiper arm 114 may be positioned below the upper surface 118a of the inner applique 118. Accordingly, the wiper arm 114 may be required to translate relative to the upper surface 118a. A slot 308 may be defined in the upper surface 118a and the sidewall 116a to permit movement of the wiper arm 114. In some embodiments, to reduce entry of water and other contaminants into the slot 308, a seal 310 may be mounted within the slot 308. The seal 310 may be made of a flexible material, such as a material having a Shore A hardness of from 30 to 50. The seal 310 may define a slit 312 aligned with the movement of the wiper arm 114, e.g., perpendicular to the axis of rotation 306. Prior to insertion of the wiper arm 114, the slit 312 may be narrower than the thickness of the portion of the wiper arm 114 positioned in the slit 312 during movement as measured perpendicular to the slit 312. The slit 312 will therefore be locally deformed and widened as the wiper arm 114 moves therethrough. The seal 310 will therefore reduce the area available for contaminants to enter the slot 308.

As best seen in FIG. 3, the seal 310 may be bent to conform to the transition from the upper surface 118a to the sidewall 116a. For example, the seal 310 may be include portions that are oriented substantially (e.g., within 10 degrees of) perpendicular to one another with a curved transition between these portions. The longevity of the seal 310 may be enhanced by placing a second slit 314 perpendicular to the slit 312 and extending on either side of the slit 312. The second slit 314 may be placed in the curved transition between the portions of the seal 310 that are substantially perpendicular to one another, e.g., at a position along a transition between the upper surface 118a and the sidewall 116a. The second slit 314 may permit free deflection of the seal 310 by the wiper arm 114 and avoid creasing or puckering of the seal 310 that might otherwise result from deflection by the wiper arm 114.

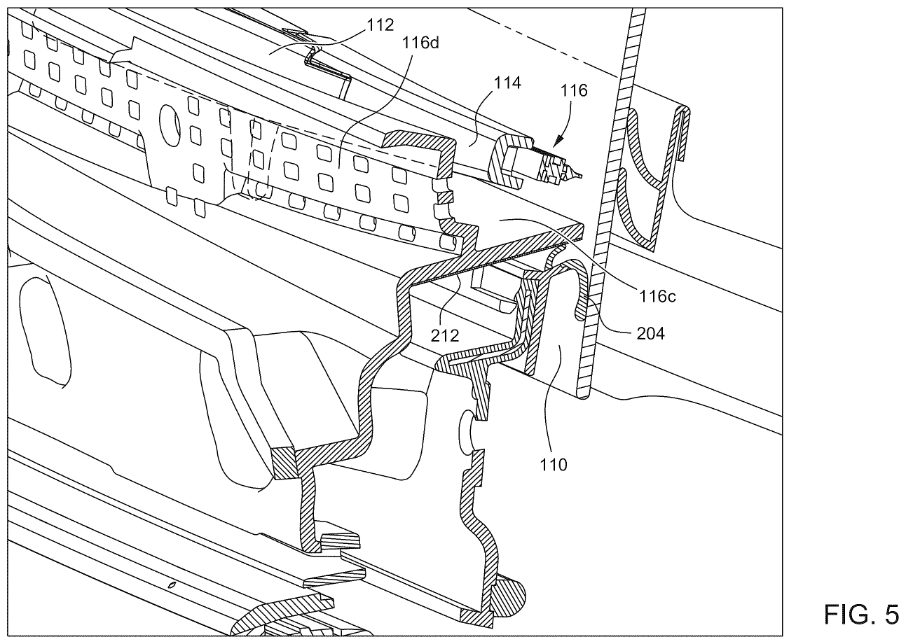

Referring to FIG. 5, the heating element 212 may be mounted to the inner applique 118 on a lower surface of the bottom wall 116c. The heating element 212 may cover at least 50, 70, 80, or 90 percent of the area of a substantially planar portion of the bottom wall 116c, e.g., a planar portion of the bottom wall 116c between the perforated rear wall 116d and the window 110 and between the sidewalls 116a, 116b. As used herein, substantially planar may be understood as having a radius of curvature of greater than 1 meter.

FIG. 5 further illustrates the relationship of the seal 204 to the receptacle 116. The seal 204, e.g., the recess 206 defined by the seal 204, may be positioned below the bottom wall 116c. Accordingly, the window 110 may likewise extend below the bottom wall 116c and engage the seal 204.

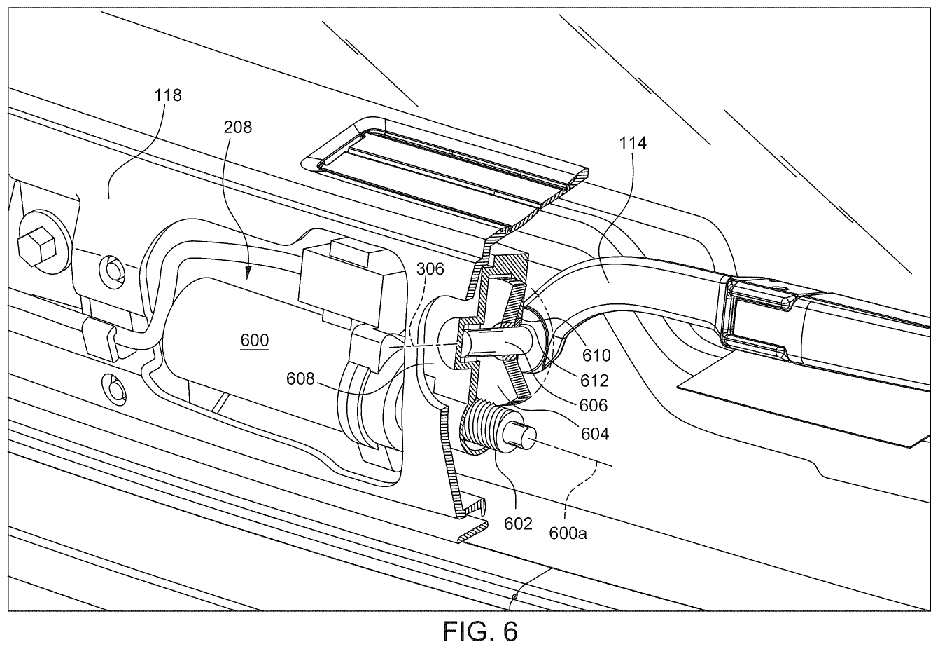

Referring to FIG. 6, the drive unit 208 may include an electric motor 600 having an axis of rotation 600a that is substantially (e.g., within 0.5 degrees) perpendicular to the axis of rotation 306 of the wiper arm 114. The axis of rotation 600a may therefore be positioned substantially (e.g., within 5 degrees of) tangent to the curvature of the portion of the outer applique 120 (see FIG. 1) extending over the drive unit 208. As shown in FIG. 6, the motor 600 may be elongated along the axis of rotation 600a such that the illustrated orientation of the motor 600 results in less protrusion of the motor 600 normal to the outer applique 120 and therefore enables a more compact design.

A worm gear 602 is coupled to the output shaft of the motor 600 and drives a gear 604 couple to an output shaft 606 defining the axis of rotation 306. The output shaft 606 is connected to the wiper arm 114. The worm gear 602 and gear 604 may be positioned within a housing 608 that is either mounted to the motor 600 or contains the motor 600. The housing 608 may define an opening 610 through which the output shaft 606 extends. A bearing 612 may be positioned in the opening 610 and extend around the output shaft 606 to facilitate rotation of the output shaft 606 relative to the housing 608. The bearing 612 may include seals and be suitable for outdoor use, e.g., tolerant to exposure to moisture and other contaminants, in order to withstand small amounts of moisture or other contaminants that may be pass through the slits 312, 314 in the seal 310.

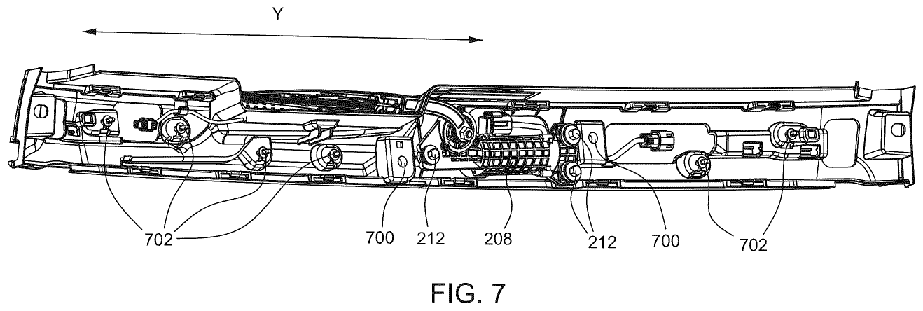

Referring to FIG. 7, as noted above, the drive unit 208 may mount to the inner applique 118 using fasteners 210. Fasteners 214 (see FIG. 2) may then extend through openings 700 positioned adjacent (e.g., within 4, 8, or 12 centimeters from the fasteners 210) and fasten the inner applique 118 to the glass carrier 200 or directly to the lower panel 102.

Other than the portion of the inner applique 118 between the openings 700, and a region around the openings 700, e.g., within a radius of 2, 4, or 6 centimeters from centers of the openings 700, referred to herein a “the structural portion,”, the inner applique 118 is not a structural member. Accordingly, portions of the inner applique 118 extending outwardly in the Y direction from the structural portion (“the non-structural portions”) may be thinner, include fewer stiffening structures, and/or include large openings. The extent of the non-structural portions on either side of the structural portion may be at least 1, 1.5, or 2 times the extent of the structural portion in the Y direction. The non-structural portions of the inner applique 118 may be mounted using non-structural fasteners suitable for decorative structures, such as the illustrated snap fasteners 702 distributed across the non-structural portion. The snap fasteners 702 may engage corresponding openings in the glass carrier 202 or lower panel 102 to secure the non-structural portions of the inner applique to the glass carrier 202 or lower panel 102.

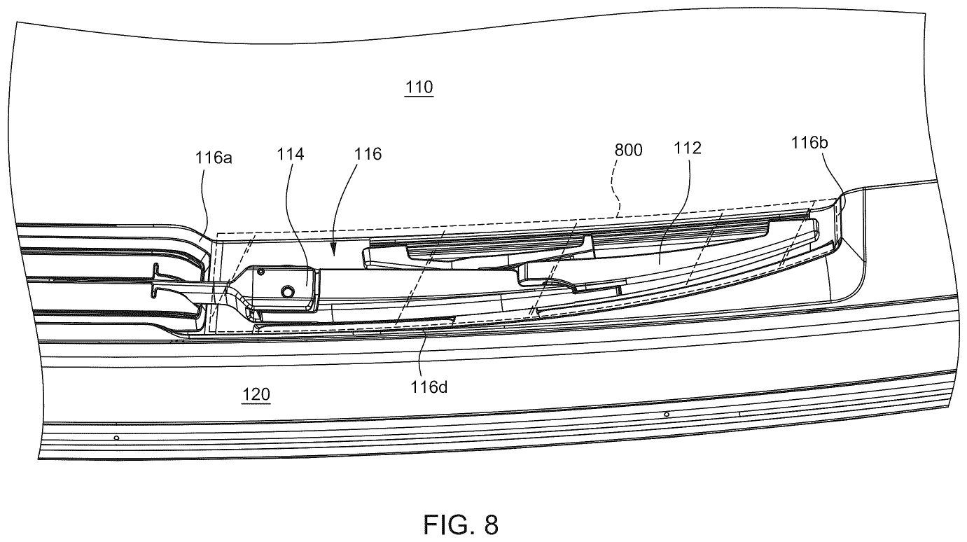

Referring to FIG. 8, in some embodiments, entry of water, snow, and other contaminants into the receptacle 116 while the wiper 112 is parked may be further reduced by mounting a cover 800 to the wiper 112 and/or wiper arm 116. The cover 800 may cover substantially all, e.g., 70, 80, 90, or 95 percent, of an area extending between the window 110 and the rearward wall 116d and between the sidewalls 116a, 116b. Stated differently, when the wiper 112 is parked, a gap of no more than 10, 5, 2, or 1 millimeter may be present between the cover 800 and surrounding structures (the window 110, the rearward wall 116d, and the sidewalls 116a, 116b). The cover 800 may be made of a rigid material (e.g., Shore A hardness greater than 60) or a flexible material (Shore A less than 60). In other embodiments, the cover 800 may be mounted to the inner applique 118 and may deflect to allow the wiper 112 and wiper arm 114 to enter the receptacle 116 and thereafter recoil to cover the receptacle 116. For example, an edge of the cover 800 may be captured between the inner applique 118 and the outer applique 120 to mount the cover 800 over the applique. The cover 800 may be formed of two pieces mounted to the inner applique and defining a slot permitting the wiper 112 and wiper arm 114 to pass therethrough.

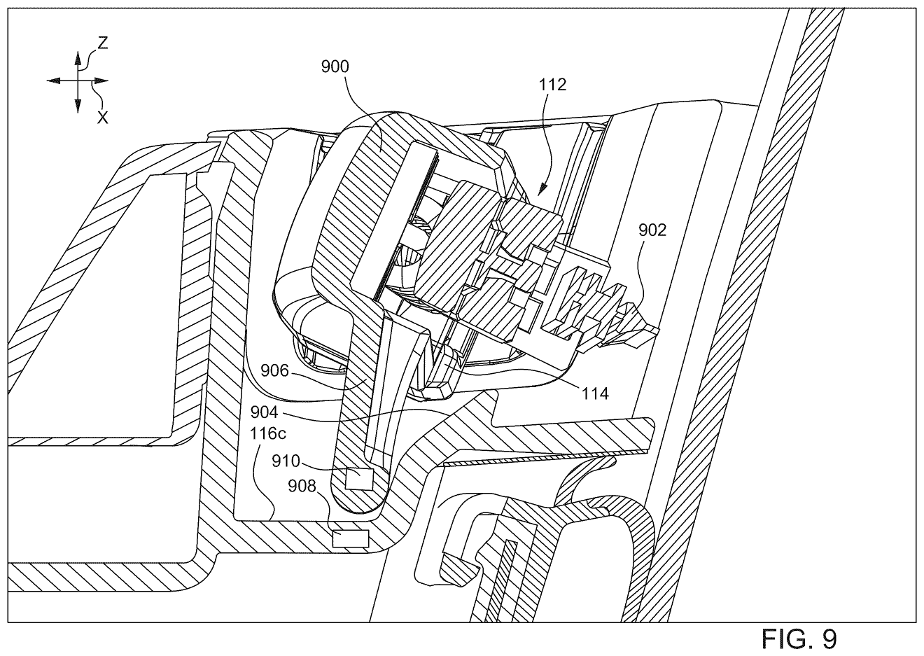

Referring to FIG. 9, the wiper 112 may include a wiper blade mount 900 that is pivotally mounted to the wiper arm 114 according to any approach known in the art. A wiper blade 902 inserts within the wiper blade mount 900 according to any approach known in the art. In some embodiments, it may be desirable to maintain the wiper blade 902 out of contact with the window 110 when the wiper 112 is parked.

The wiper blade mount 900 may engage a ramp 904 formed in the receptacle 116, such as formed on the inner applique 118 protruding upwardly from the bottom wall 116c. The ramp 904 may urge the wiper blade mount 900 away from the window 110 sufficiently that the wiper blade 902 does not contact the window 110. For example, the ramp 904 may be sloped downwardly (sloping away from the upper surface of the inner applique 118a and toward the bottom wall 116c) with distance from the window 110 along the X direction. The ramp 904 may have a uniform slope or areas of different slope as shown in FIG. 9. For example, a first region with a first slope closest to the window 110 and a second region with a second slope that is greater than the first slope, the first region being positioned between the second region and the window 110 along the X direction.

The wiper blade mount 900 may define a protrusion 906 configured to engage the ramp 904. The protrusion 906 may rest on or be adjacent (e.g., within 5 millimeters) the bottom wall 116c when the wiper 112 is parked.

In some embodiments, it may be desirable to sense whether the wiper 112 has been successfully parked. In some embodiments, a Hall effect sensor 908 may be mounted in or on the receptacle 116c, such as in, on, or below the bottom wall 116c. A magnet may be mounted to the wiper 112, such as in or on the protrusion 906 or elsewhere on the wiper 112, or to the wiper arm 114, such that that Hall effect sensor 908 will sense the magnetic field of the magnet 910 when the wiper 112 is parked.

The illustrated Hall effect sensor 908 is one example of a parking sensor that is capable of detecting that the wiper 112 is parked. Other types of sensors, such as a contact sensor (e.g., button) that senses contact with the wiper 112 may likewise be used,

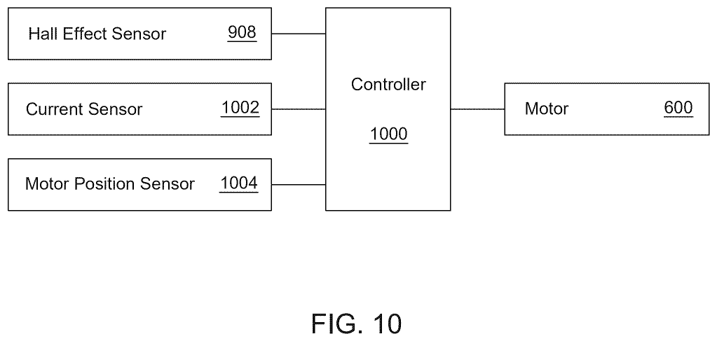

Referring to FIG. 10, a vehicle to which the rear liftgate 100 is mounted may include a controller 1000, such as an electronic control unit (ECU) or other type of controller. The controller 1000 may receive the output of the Hall effect sensor 908. The controller 1000 may further receive the output of a current sensor 1002 sensing the amount of current drawn by the motor 600. In some embodiments, the motor 600 includes a motor position sensor 1004 such that the actual amount of rotation of the motor 600 is known. The controller 1000 may therefore receive the output of the motor position sensor 1004. The controller 1000 may translate the output of the motor position sensor 1004 to an angular displacement of the wiper 112 and derive an estimated angular position of the wiper. The controller 1000 may use the illustrated inputs to control the motor 600 to achieve a desired position and speed of the wiper 112.

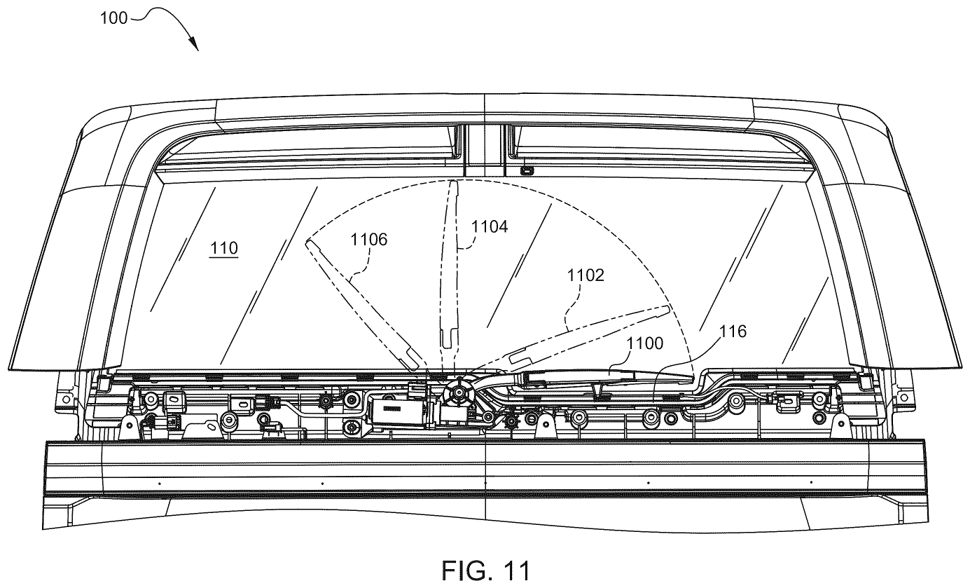

Referring to FIG. 11, for example, the wiper 112 may be movable among various positions. In a parked position 1100, the wiper 112 is positioned within the receptacle 116 and can be sensed using a parking sensor, e.g., the Hall effect sensor 908. The wiper 112 and wiper arm 114 are positioned below the upper surface 118a of the inner applique 118 in the parked position as discussed above.

The wiper 112 may have a start position 1102 that is angularly offset from the parked position 1100, a service position 1104, and an end position 1106. During normal operation, the controller 1000 may cause the motor 600 to oscillate the wiper 112 between the start and end positions 1102, 1106. When the wiper 112 is not in use, the controller 1000 may cause the motor 600 to drive the wiper 112 to the parked position 1100. When in an intermittent mode of operation, the controller 1000 may pause movement of the wiper 112 between strokes at either the start position 1102 or the end position 1106 or alternate therebetween.

The controller 1000 may cause the motor 600 to move the wiper 112 to the service position 1104, such as in response to an input received from a user, to facilitate servicing of the wiper 112, such as replacement of the wiper blade 902. In the illustrated embodiment, the service position 1104 is between the start and end positions 1102, 1106. This is particularly helpful since the wiper 112 is less accessible when in the recess 116. The controller 1000 may cause the wiper 112 to remain in the service position for a fixed amount of time or until instructed to move the wiper 112 to the parked position 1100 by an input received from a user.

The controller 1000 may sense successful parking of the wiper 112 using various events. For example, as the wiper 112 approaches the parked position, the estimated angular position of the wiper 112 will indicate the angular position is at a point where the wiper 112 engages the ramp 904. Likewise, the current sensor 1002 may produce an output indicating increased resistance from sliding the wiper 112 over the ramp and overcoming the resulting friction as well as any biasing force between the wiper 112 and wiper arm 114 that biases the wiper blade 902 into engagement with the window 110. When in the parked position 1100, the estimated angular position of the wiper will correspond to the parked position, the Hall effect sensor 908 may indicate proximity of the magnet 910, and there may be a rise in the output of the current sensor 1002 as the interference between the wiper 112 and bottom wall 116c prevents further movement. The controller 1000 may detect all of these events and stop invoking rotation of the motor 600.

Following being placed in the service position, the controller 1000 may perform a calibration step, e.g., to relate the output of the motor position sensor 1004 to the estimated angular position of the wiper 112. For example, the output of the Hall effect sensor 908 and current sensor may be used to detect that the wiper 112 is in the parked position 1100 as described above. The estimated angular position of the wiper 112 as output from the motor position sensor 1004 (or obtained from data derived therefrom) may therefore be recorded by the controller 1000 as corresponding to the parked position 1100. The calibration step may also be performed upon manufacture. For example, the arm 114 may be installed in any position and then the calibration step may be performed.

In some instances, there may be ice or snow crusted on the window 110 that resists movement of the wiper 112. The controller 1000 may detect such obstructions based on an output of the current sensor 1002 indicating a current draw that is higher than an expected value for the current estimated angular position of the wiper 112 and/or based on the change in the estimated angular position being less than an expected value for the current estimated angular of the wiper 112 and/or indicating complete stoppage of the wiper 112. In response, the controller 1000 may cause the motor 600 to reverse the direction of movement of the wiper 112 until the start or end position 1102, 1106 is reached. The controller 1000 may then again reverse the direction of movement of the wiper 112 and attempt to perform a complete stroke of the region between the start and end positions 1102, 1106. If the wiper 112 is found to be obstructed at the same position (e.g., within 10 degrees of the same position) based on the current draw and or rate of change in angle of the wiper 112, an obstruction may be verified and the controller 1000 may cause the wiper 112 to return to the parked position 1100 and generate an error message, such as output on an infotainment screen of the vehicle.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A vehicle assembly comprising:
a vehicle door defining a window opening, the vehicle door including a structure having a surface defining a portion of a lower edge of the window opening and a recess extending downwardly from the surface;
a window extending across the window opening; and
a window wiper mounted to the structure and having a parked position in which the window wiper is positioned in the recess.

2. The vehicle assembly of claim 1, wherein a perforated wall extends across the recess and permits fluid to drain from the recess.

3. The vehicle assembly of claim 2, wherein the perforated wall extends across a first side of the recess and the window extends across a second side of the recess opposite the first side.

4. The vehicle assembly of claim 2, wherein the structure defines a channel under the perforated wall and configured to conduct fluid away from the recess to a side of the vehicle door.

5. The vehicle assembly of claim 1, wherein a drive unit is mounted to the structure, an arm being mounted to the drive unit and the window wiper being mounted to the arm, the structure defining a slot permitting movement of the arm within the slot, the slot extending across a portion of the surface and the recess.

6. The vehicle assembly of claim 5, further comprising a seal positioned in the slot, the seal defining a first slit permitting movement of the arm within the first slit.

7. The vehicle assembly of claim 6, wherein the seal further defines a second slit extending substantially perpendicular to the first slit and extending to either side of the first slit, the second slit being positioned at a curved transition between a first portion of the seal and a second portion of the seal that is angled relative to the first portion.

8. The vehicle assembly of claim 7, wherein the second portion is substantially perpendicular to the first portion.

9. The vehicle assembly of claim 5, wherein the drive unit includes a motor and a worm gear having a first axis of rotation, a drive gear engaging the worm gear and having a second axis of rotation that is perpendicular to the first axis of rotation, the arm being mounted to the drive gear.

10. The vehicle assembly of claim 5, wherein the structure is an applique configured to secure to a lower panel of the vehicle door, the applique including:
a structural portion, the drive unit being mounted to the structural portion and the structural portion being mounted to the lower panel of the vehicle door; and
non-structural portions extending outwardly from the structural portion and being mounted to the lower panel of the vehicle door using non-structural fasteners.

11. The vehicle assembly of claim 10, wherein the non-structural fasteners include snap fasteners.

12. The vehicle assembly of claim 10, wherein:
the applique is an inner applique;
the vehicle assembly further comprising an outer applique secured to the inner applique;
the inner applique includes a perforated wall extending across the recess and permitting fluid to drain from the recess;
the inner applique includes a channel under the perforated wall and configured to conduct fluid away from the recess to a side of the vehicle door; and
the vehicle assembly includes a seal positioned around the perforated wall and the channel, the seal being positioned between the inner applique and the outer applique.

13. The vehicle assembly of claim 1, further comprising a cover secured to at least one of the window wiper and the structure and configured to substantially cover the recess.

14. The vehicle assembly of claim 1, further comprising a heating element mounted to the structure and configured to melt ice within the recess.

15. The vehicle assembly of claim 14, wherein the heating element is mounted below a bottom wall of the recess.

16. The vehicle assembly of claim 1, further comprising a magnet mounted to the window wiper and a Hall effect sensor mounted to the structure and configured to sense the magnet when the window wiper is positioned within the recess.

17. The vehicle assembly of claim 1, further comprising a ramp positioned in the recess and configured to urge the window wiper away from the window when the window wiper is positioned in the recess.

18. The vehicle assembly of claim 1, wherein the vehicle door is a rear liftgate.

19. An apparatus comprising:
a portion of a vehicle defining a window opening;
a structure secured to the portion and having a surface defining a portion of a lower edge of the window opening and a recess extending downwardly from the surface;
a window extending across the window opening; and
a window wiper mounted to the structure and having a parked position in which the window wiper is positioned in the recess.

20. An apparatus comprising:
a structure configured to secure along a lower edge of a window opening defined by a portion of a vehicle, the structure having a surface defining a portion of a lower edge of the window opening and a recess extending downwardly from the surface;
a window wiper mounted to the structure and having a parked position in which the window wiper is positioned in the recess; and
a drive unit mounted to the structure and coupled to the window wiper to actuate the window wiper.
